(19) United States
(12) Patent Application Publication
(10) Pub. No.: US 2009/0058008 A1
(43) Pub. Date: Mar. 5, 2009

(54) PRINTED TARGET APPARATUS AND METHOD

(76) Inventors: Ryan J. Baumgartner, Fulda, MN (US); Clark J. Stoel, Jasper, MN (US)

Correspondence Address: MERCHANT & GOULD PC, P.O. BOX 2903, MINNEAPOLIS, MN, 55402-0903, US

(21) Appl. No.: 11/847,877

(22) Filed: Aug. 30, 2007

(51) Int. Cl. F41J 1/00; B29C 45/00

(52) U.S. Cl. 273/408; 273/409; 264/319; 264/238

(57) ABSTRACT

A target includes a face member, a side wall, and an image. The face member includes a first edge that at least partially surrounds the face member. The side wall is connected to the face member at the first edge. The side wall increases the strength and stability of the target. The image is located on a surface of the face member. A method of making the target includes obtaining a sheet of material; heating the sheet of material; using a mold to define a face member, side wall member, and flange member from the heated sheet of material; cooling the sheet of material after defining the face member, side wall member, and flange member; removing an excess portion of the flange member; and printing an image on the sheet of material.

### TECHNICAL FIELD

The present disclosure is related to targets, and more particularly to targets having a printing surface.

### BACKGROUND

A target is often used when shooting, propelling, or hurling an object for sport or hobby. Such objects include bullets, arrows, darts, ballistic balls (“BBs”), pellets, rocks, balls, and other similar objects. Some of these objects are often propelled by a firearm, such as a pistol, rifle, air gun, or shotgun. Other objects are propelled by a sling, sling shot, bow, or are hurled manually.

One type of target is made from a sheet of paper and includes a printed image. Probably the most common printed image on a target includes a pattern of concentric rings, known as a “bullseye.” Other targets include objects, such as used cans, cardboard boxes, glass bottles, clay targets (also known as “clay pigeons”), or a variety of other target objects.

Such targets are often used during target practice, such as to improve the accuracy of a hunter or marksman. Targets are also used during competitions to determine the accuracy of the marksman. In these situations, the accuracy of the shot is determined by whether or not the target is hit by the object, and if hit, by how closely the target it hit to a preferred location on the target, such as the bullseye.

Existing targets, such as paper targets, often suffer from a number of problems. For example, paper targets are easily torn. They are also sometimes damaged by rain and water. In addition, wind can easily cause paper targets to wave or otherwise move, making it difficult to determine the accuracy of a shot. These and other disadvantages in the art are solved by some embodiments according to the present disclosure.

### SUMMARY

A target or display system includes a face member that defines a printing surface upon which an image is printed. In some embodiments, a target has a general shape of an animal profile, and the printed image is an image of the animal. A side wall extends from the face for added strength and stability.

One aspect is an apparatus including a face member, a side wall, and an image. The face member has a first edge that at least partially surrounds the face member. The side wall has a second edge and a third edge. The side wall is connected to the first edge of the face member at the second edge of the sidewall. The image is located on the printing surface of the face member.

Another aspect is a method of forming a target. The method includes obtaining a sheet of material; heating the sheet of material; using a mold to define a face member, side wall member, and flange member from the heated sheet of material; cooling the sheet of material after defining the face member, side wall member, and flange member; removing an excess portion of the flange member; and printing an image on the sheet of material.

Yet another aspect is a target comprising a face member, an image, a side wall, and a flange. The face member has a substantially planar printing surface and a first edge at least partially surrounding the face member. The first edge has a shape of an animal. The image is located on the printing surface of the face member and includes the likeness of the animal. The side wall has a second edge and a third edge. The sidewall is connected to the first edge of the face member at the second edge of the sidewall. The side wall extends from the first edge. The third edge has a shape of the animal. The flange member has a fourth edge and a fifth edge. The flange member is connected to the third edge of the sidewall at the fourth edge of the flange member. The flange member extends from the third edge in a direction substantially parallel with a plane of the printing surface.

There is no requirement that an arrangement, system, or method disclosed herein include all features characterized herein to obtain some advantage according to this disclosure.

### BRIEF DESCRIPTION OF THE DRAWINGS

FIG. 1 is a front perspective view of an example target according to the present disclosure.

FIG. 2 is a rear perspective view of the example target shown in FIG. 1.

FIG. 3 is a front view of the example target shown in FIG. 1.

FIG. 4 is a left side view of the example target shown in FIG. 1.

FIG. 5 is a cross sectional view of a portion of the example target shown in FIG. 1.

FIG. 6 is a front view of an example image that can be applied to the target shown in FIG. 1.

FIG. 7 is a rear view of another example target according to the present disclosure.

FIG. 8 is a perspective view of a stack of the targets shown in FIG. 1.

FIG. 9 is a front perspective view of another example target according to the present disclosure.

FIG. 10 is a rear perspective view of another example target according to the present disclosure.

FIG. 11 is a block diagram of an example manufacturing line for manufacturing the target shown in FIG. 1.

FIG. 12 is a block diagram illustrating an example system for performing various tasks relating to the example target shown in FIG. 1.

FIG. 13 is a screen shot of an example user interface generated by the system shown in FIG. 12.

FIG. 14 is another screen shot of the example user interface shown in FIG. 13.

FIG. 15 is another screen shot of the example user interface shown in FIG. 13.

### DETAILED DESCRIPTION

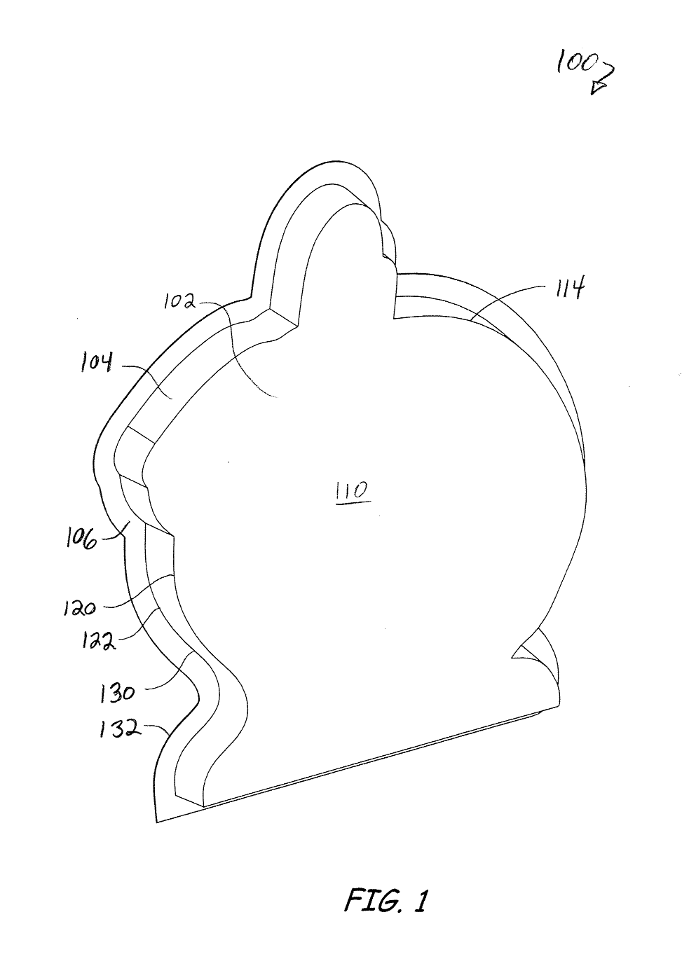

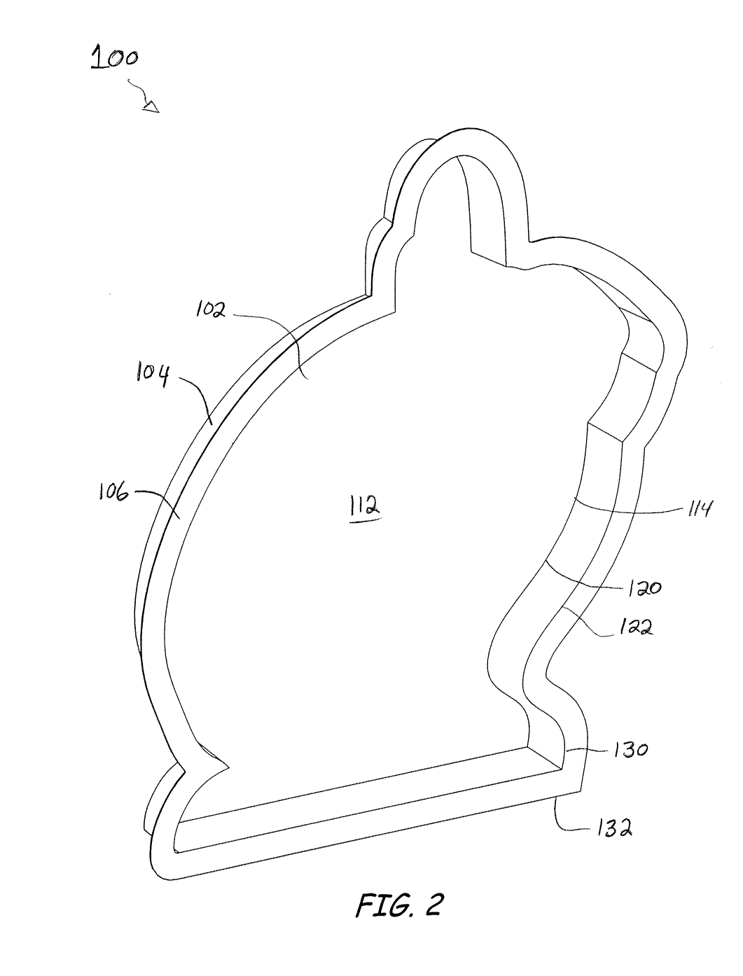

FIGS. 1-2 illustrate perspective views of an example target 100 according to the present disclosure. FIG. 1 is a front perspective view of the example target 100. FIG. 2 is a rear perspective view of the example target 100. The illustrated example of target 100 has the silhouette of a rabbit, but many other shapes are also possible, as described herein.

In the illustrated embodiment, target 100 includes face 102, side wall 104, and flange 106. Face 102 includes printing surface 110, interior surface 112, and edge 114. Side wall 104 includes edge 120 and edge 122. Flange 106 includes edge 130 and edge 132.

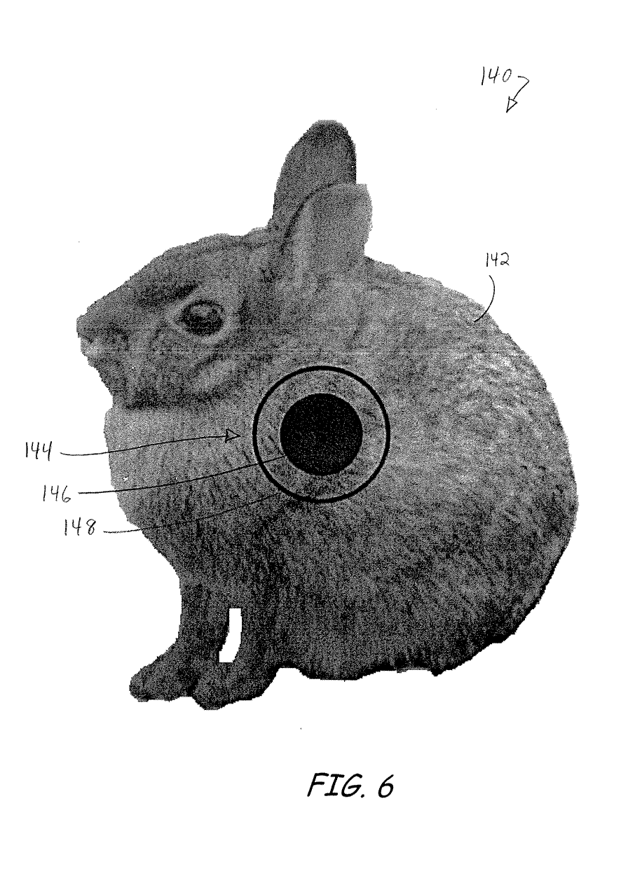

Face 102 is a substantially planar member with printing surface 110 and interior surface 112. Interior surface 112 is opposite printing surface 110. Face 102 includes edge 114. In the illustrated embodiment, edge 114 surrounds face 102 and has the general shape of a rabbit. In some embodiments, an image is printed on printing surface 110. In some embodiments, the image is a dot and one or more concentric circles to form a bullseye. In other embodiments, the image includes a picture, graphic, or drawing. In other embodiments, the image includes a picture, graphic, or drawing including a bullseye. An example image is shown in FIG. 6, which is an image of a rabbit and a bullseye.

Side wall 104 is connected to edge 114 at edge 120. Side wall 104 extends from edge 120 to edge 122. In the illustrated embodiment, edges 120 and 122 have the general shape of a rabbit, similar to edge 114. In one embodiment, side wall 104 extends perpendicular to face 102. In other embodiments, side wall 104 includes a draft or a taper. The draft allows target 100 to take up less space when stacked with other targets of the same shape.

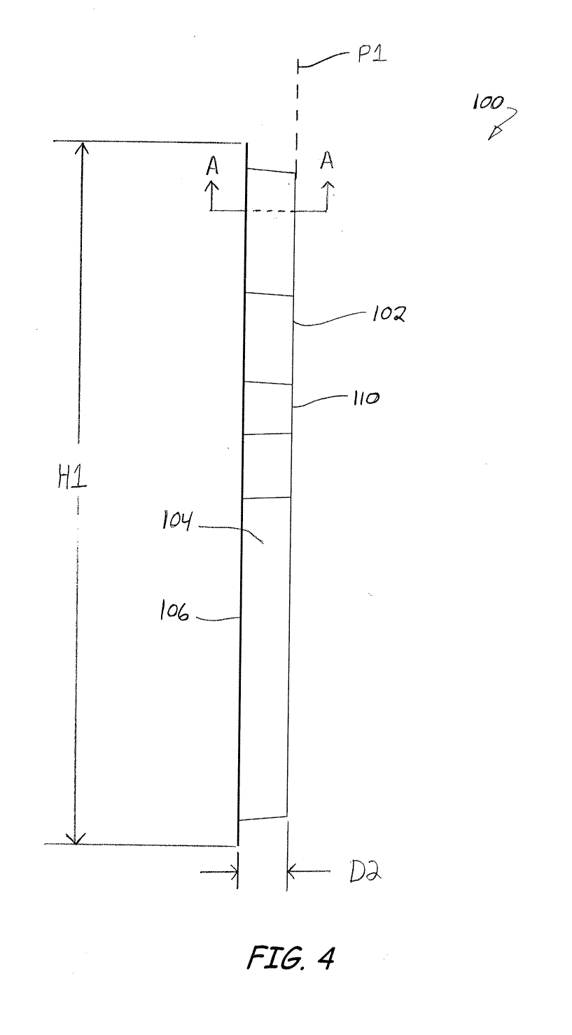

Flange 106 is connected to edge 122 at edge 130. Flange 106 extends from edge 130 to edge 132. In the illustrated embodiment, edges 130 and 132 have the general shape of a rabbit, similar to edges 114, 120, and 122. In one embodiment, flange 106 is substantially parallel to a plane P1 passing through face 102 (shown in FIG. 4). In other embodiments, flange 106 includes an angle from a direction parallel with face 102. In yet other embodiments, flange 106 is not included. In some embodiments, flange 106 is used to attach target 100 to a support such as a stake, post, wall, backstop, or other surface or mounting device. Fasteners such as pins, tacks, nails, staples, screws, tape, adhesive, and other known fasteners can be used to connect flange 106 to the support. In some embodiments a hole or slot is formed in flange 106 for easier attachment. In another embodiment, a hole or slot is formed in side wall 104, such as to aid in engagement of target 100 with a stake or chord.

One of the benefits of target 100 is improved strength and stability. Some of this strength and stability is provided by side wall 104 and flange 106. For example, if target 100 is placed in a windy environment, side wall 104 and flange 106 will act to prevent or at least reduce movement and deformation of target 100. In contrast, conventional paper targets are prone to undesirable waving or flapping in the wind.

In one embodiment, target 100 is made of polyvinyl chloride (PVC). Some types of PVC have been found to be beneficial in that they are thermoformable in desired shaped for targets. Some types of PVC can withstand repeated shots from an object, such as a bullet, without shattering or fracturing. For example, a bullet can pierce the PVC material, leaving a hole sized approximately the outer profile of the bullet, while the PVC material is resistant to cracking or fracturing around the hole. Alternative embodiments of target 100 are formed of high impact polystyrene (HIPS), polyethylene, wood, paper, cardboard, metal, or metal alloys.

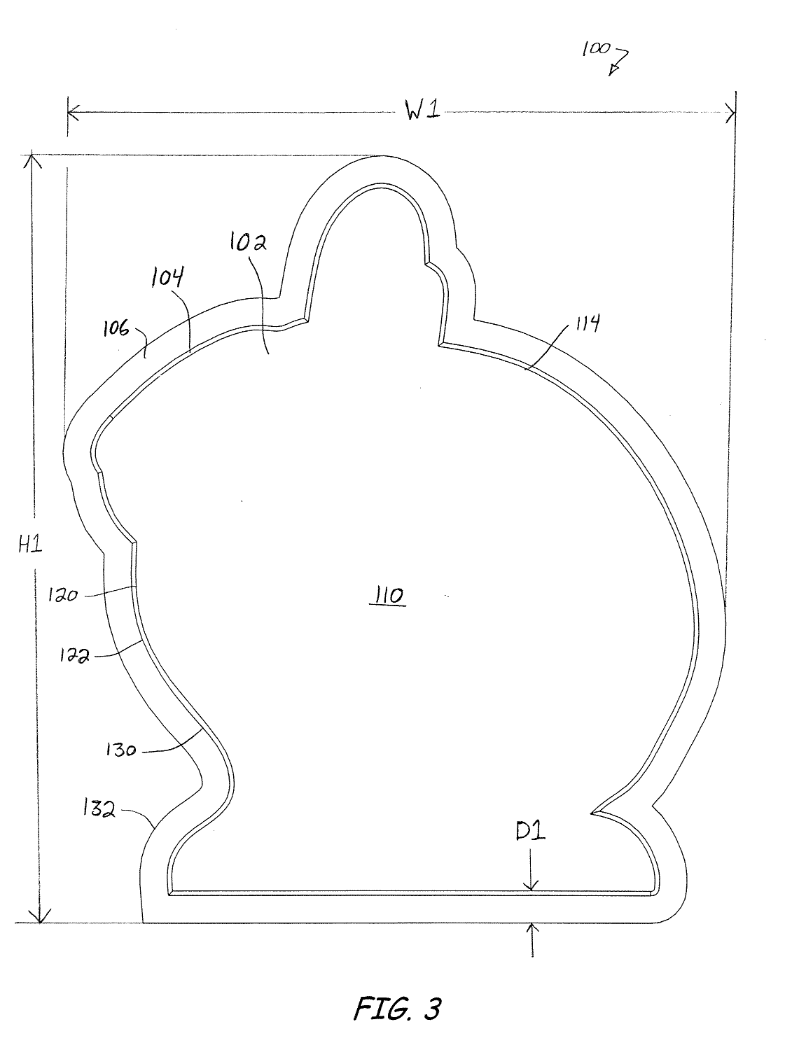

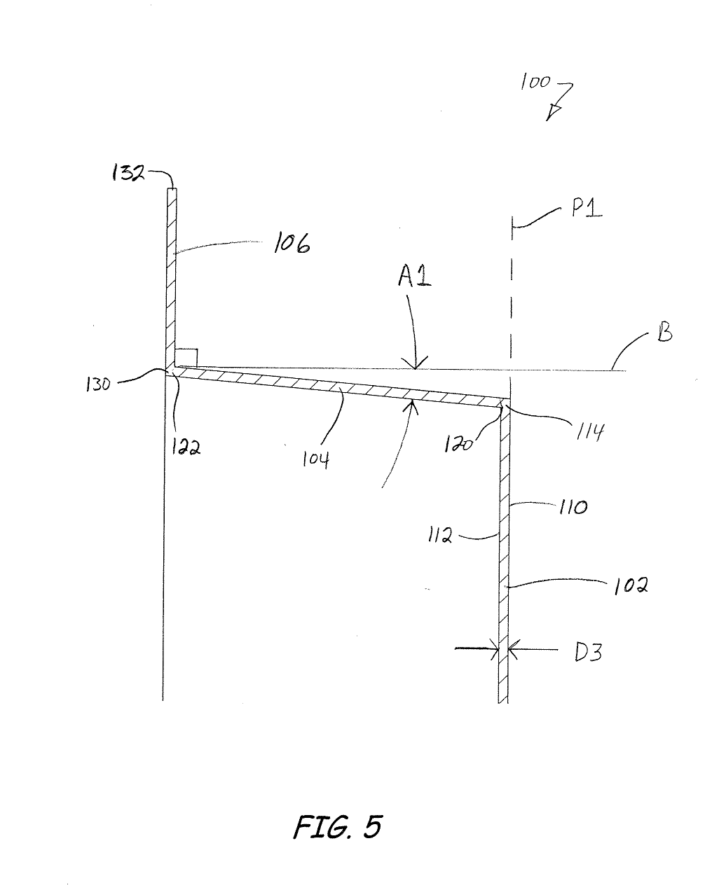

FIGS. 3-4 further illustrate example target 100. FIG. 3 is a front view of example target 100. FIG. 4 is a left side view of the example target 100. In the illustrated embodiment, target 100 includes face 102, side wall 104, and flange 106. Face 102 includes printing surface 110, interior surface 112, and edge 114. In one embodiment, face 102 is in a plane P1 that extends through face 102. Side wall 104 includes edge 120 and edge 122. Flange 106 includes edge 130 and edge 132. Line A-A, shown in FIG. 4 illustrates the location of the cross sectional view shown in FIG. 5.

Examples of possible dimensions of example target 100 are as follows. H1 is the overall height of target 100. H1 is typically in a range from about 1 inch to about 60 inches, and preferably from about 4 inches and about 12 inches. W1 is the overall width of target 100. W1 is typically in a range from about 1 inch to about 60 inches, and preferably from about 4 inches to about 12 inches. D1 is the width of flange 106. D1 is typically in a range from about 0.01 inches to about 12 inches, and preferably from about 0.1 inches to about 1 inch. D2 is the thickness of target 100 from face 102 to flange 106. D2 is typically in a range from about 0.01 inches to about 24 inches, and preferably from about 0.25 inches to about 1 inch.

FIG. 5 is a cross sectional view of a portion of target 100 taken at line A-A, shown in FIG. 4. In the illustrated embodiment, target 100 includes face 102, side wall 104, and flange 106. Face 102 includes printing surface 110, interior surface 112, and edge 114. Side wall 104 includes edge 120 and edge 122. Flange 106 includes edge 130 and edge 132.

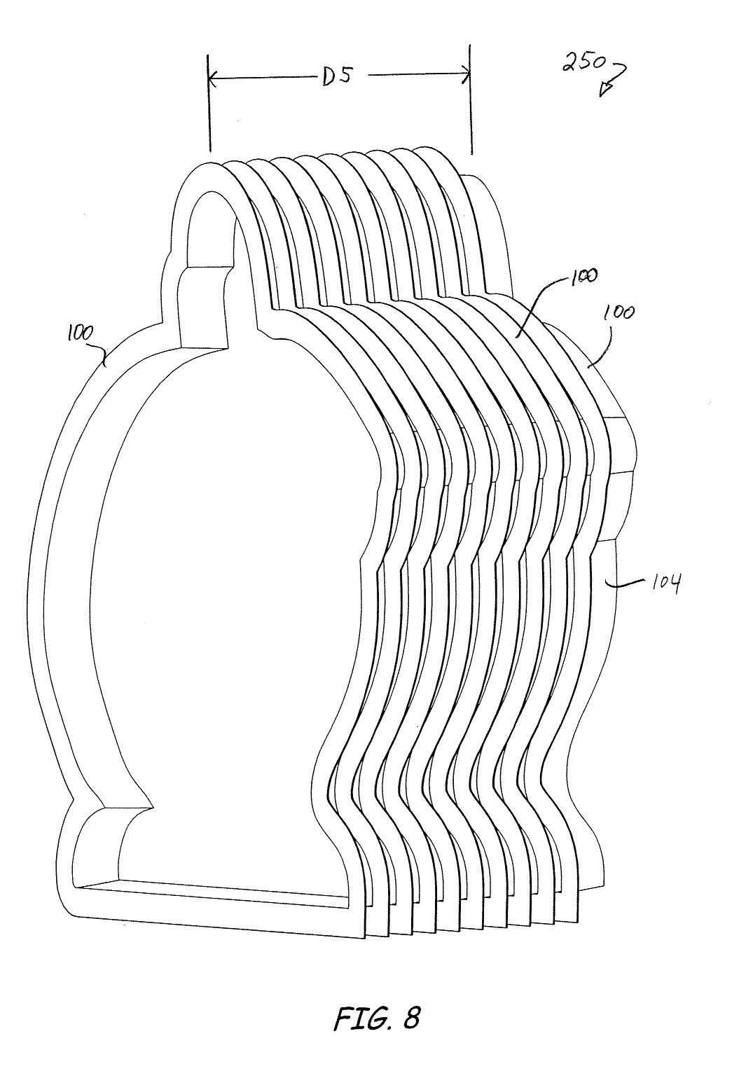

The illustrated example of target 100 includes side wall 104 having a draft angle A1. In the illustrated embodiment, angle A1 is measured from a line B perpendicular to the plane of flange 106. A1 is typically in a range from about 0 degrees to about 45 degrees, and preferably from about 2 degrees to about 5 degrees. One of the benefits of the draft is that is allows multiple targets 100 to be stacked, such as shown in FIG. 8.

D3 is the thickness of the material of face 102. In one embodiment, side wall 104 and flange 106 has roughly the same material thickness as face 102. In another embodiment, the thickness of side wall 104 is less than the thickness of face 102 because side wall 104 is formed by stretching the material of that region, resulting in a thinner side wall 104. D3 is typically in a range from 0.001 inches to about 0.08 inches, and preferably from about 0.012 inches to about 0.025 inches. Other embodiments include other materials having different thicknesses.

FIG. 6 is a front view of an example image 140. In the illustrated example, image 140 includes graphic 142 and bullseye 144. Bullseye 144 includes dot 146 and one or more concentric circles 148. Image 140 is applied in some embodiments to printing surface 110 of face 102 (shown in FIG. 1). In one embodiment, image 140 is applied by printing image 140 onto face 102, such as with a digital printer.

In the illustrated embodiment, graphic 142 is a photographic image of a rabbit. In other embodiments, a wide variety of other graphics 142 can be used. Examples include photographs or drawings of animals such as game animals, people, places, or things. Other embodiments include text, slogans, logos, or advertisements. As described herein, image 140 is selected from a set of available images in some embodiments. In another embodiment, image 140 is a custom image provided by the customer.

In some embodiments, image 140 also includes bullseye 144 including dot 146 and one or more concentric circles 148. Bullseye 144 provides an identifiable location on target 100 (shown in FIG. 1) to aim at. In addition, bullseye 144 allows for a determination of how accurate a shot was, by determining the distance between the center of dot 146 and a hole or indentation on the target resulting from impact with an object such as a bullet. In some embodiments, bullseye 144 is applied to target 100 at the same time as image 140. In other embodiments, bullseye 144 is applied to target 100 after the application of image 140, such that application of bullseye 144 is a separate step. In this way, some embodiments include an option for a customer to select whether or not a bullseye is desired on target 100, and if so, can also allow the customer to select the desired location of bullseye 144 prior to application of bullseye 144.

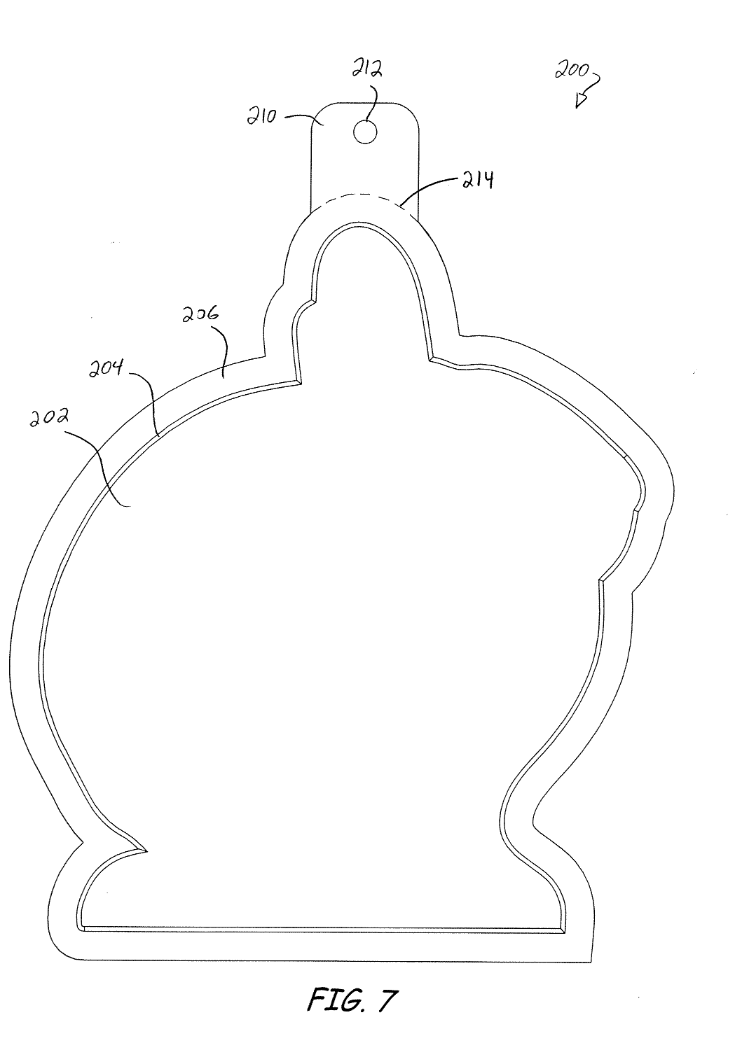

FIG. 7 is a rear view of another example target 200. Example target 200 includes face 202, side wall 204, and flange 206. Example target 200 is the same as target 100, such as shown in FIG. 1, except that target 200 also includes hang tag 210. Hang tag 210 is a flap that extends from flange 206. In the illustrated embodiment, hang tag 210 includes hole 212. Hang tag 210 allows one or more targets 200 to be hung, such as to display target 200 in a retail store, or to hang target 200 during use.

In some embodiments, target 200 also includes perforation 214. Perforation 214 allows hang tag 210 to be removed prior to use. For example, hang tag 210 is used to hang one or more targets 200 on a display rack in a store. After target 200 is purchased, the user removes hang tag 210 by ripping along perforation 214, and discarding hang tag 210. After removing hang tag 210, target 200 is then used.

FIG. 8 is a perspective view of a stack 250 of targets 100. In this embodiment, ten targets 100 (shown in FIG. 1) have been stacked against one another. Due to the draft of side walls 104 (shown in FIG. 5), targets 100 are able to stack 250 in a nested arrangement, such that they consume much less space than the sum of their thicknesses. For example, the thickness of a single target 100 is D2 (such as shown in FIG. 4). Without the draft in side walls 104, D5 would be equivalent to the product of D2 times the number of targets 100 in stack 250. For example, if ten targets were stacked together, D5 would be equivalent to 10×D2. However, with the draft of side walls 104, targets 100 are able to nest within each other, such that less space is consumed by stack 250.

To illustrate the space savings, a percentage can be defined. Consider the situation in which a first target is going to be stacked with a second target. The first target has a thickness. When the second target is stacked with the first, the second target adds only a percentage of the thickness to the stack. In one example embodiment, the percentage of the thickness that is added by the second target is in a range from about 5% to about 95%, and preferably from about 50% to about 90%.

In such an example, each additional target 100 that is added to stack 250 increases the depth of stack 250 only about 20% of D2 to about 50% of D2. As a result, if ten targets 100 are able to be 80% nested (such that 20% of the thickness is not nested), D5 is equal to D2+(9×0.20) D2, which is equal to 2.8×D2. Therefore, the draft of side walls 104 provides a considerable space savings for storage, shipping, and display of stack 250.

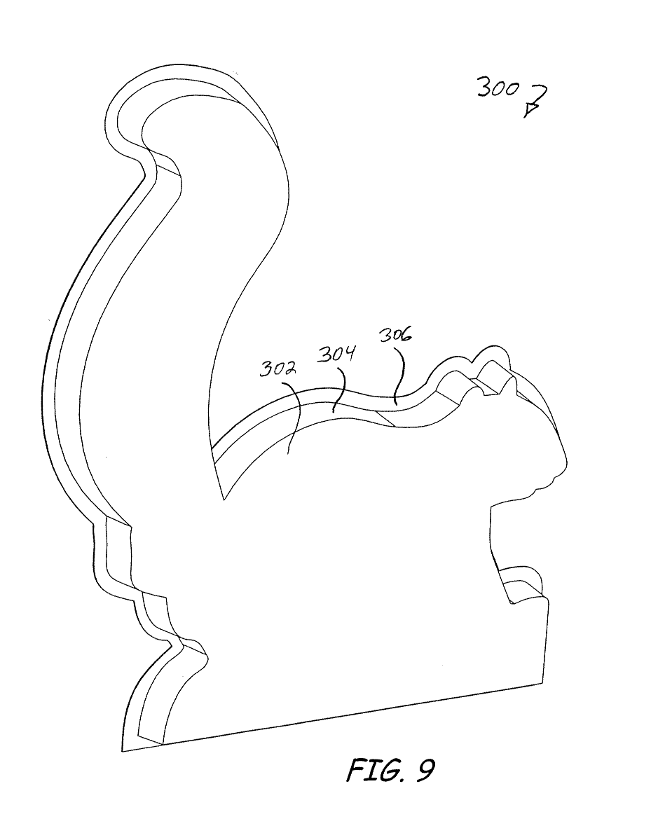

FIG. 9 is a front perspective view of example target 300. This illustrated embodiment is provided to show that targets are not limited to rabbit shapes. Example target 300 has a general shape of a squirrel. A wide variety of other shapes are also possible, such as a square, rectangle, oval, triangle, other multi-sided shape, or a shape mimicking an object, person, animal, fish, insect, bird, or reptile. Target 300 includes face 302, side wall 304, and flange 306. Face 302, side wall 304, and flange 306 are similar to face 102, side wall 104, and flange 106 except that they are arranged to form the general shape of a squirrel, rather than a rabbit. It is noted that alternative embodiments include additional features. For example, in some alternative embodiments target 300 is formed of a complex three dimensional shape, such as to form the contours of a squirrel. In such an embodiment, face 102 is not a completely planar surface, but rather includes a multi-dimensional shape across at least a portion of face 102. In some similar embodiments, all or some portions of side wall 104 and flange 306 are not required.

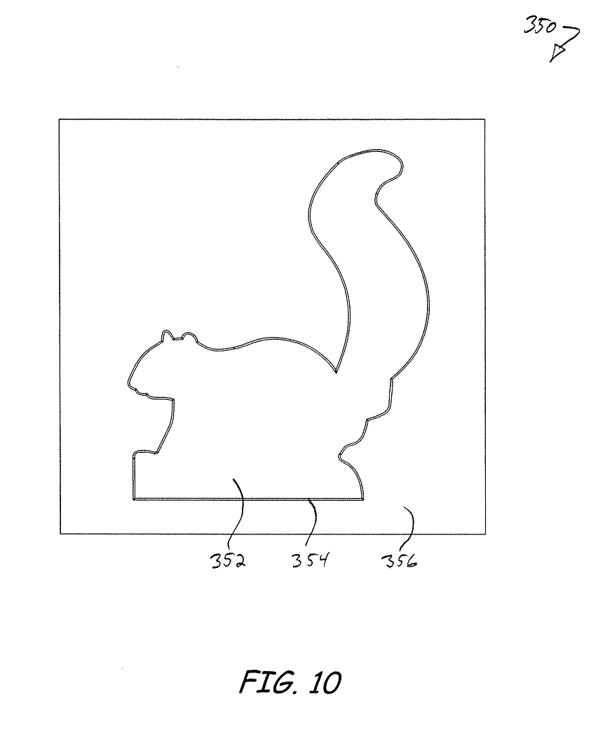

FIG. 10 is a rear perspective view of another example target 350. Example target 350 includes face 352, side wall 354, and flange 356. Target 350 is similar to target 300, except that flange 356 is formed to have a different shape than face 352 and side wall 354. Face 352 and side wall 354 both are formed to have a silhouette of a squirrel, but flange 356 is formed to have a rectangular shape. One of the benefits of example target 350 is that it does not require a custom shaped cutting die to cut out a squirrel-shaped flange. Instead, a rectangular (or other desired shape) cutting die can be used to cut flange 356 regardless of the shape of face 352 and side wall 354. Alternatively, in some embodiments a cutting die is not required at all if stock is originally provided having the general shape of flange 356. Another benefit of example target 350 is that additional surface area is available for the target. This is beneficial, for example, if a shot misses face 352. The location of the shot can still be identified if it strikes anywhere within the enlarged flange 356. This allows the person making the shot to adjust the aim accordingly in subsequent shots.

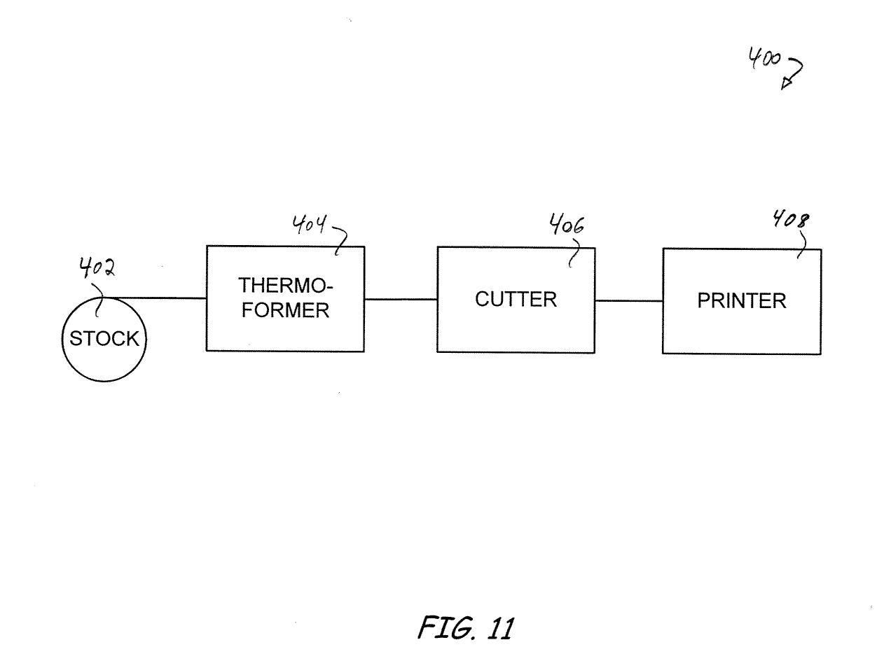

FIG. 11 is a block diagram illustrating an example manufacturing line 400 and method of manufacturing target 100. Example manufacturing line 400 includes stock 402, thermoformer 404, cutter 406, and printer 408. The process begins with the introduction of stock 402 to manufacturing line 400. In one embodiment, stock 402 is a material such as thermoplastic, polyvinyl chloride (PVC), or is a metal or a metal alloy. Stock 402 is illustrated as being provided in a roll, but could also be provided in individual sheets. In one embodiment, stock 402 is provided in a roll having a width in a range from about 10 inches to about 60 inches, and preferably from about 24 inches to about 30 inches. When unrolled, stock 402 has a thickness in a range from about 0.001 inches to about 0.08 inches, and preferably from about 0.012 inches to about 0.025 inches. In one embodiment, stock 402 is white, such that image 140 (e.g., shown in FIG. 6) can be easily seen. In other embodiments, any other color of stock can be used as desired.

Stock 402 is provided to thermoformer 404. Thermoformer 404 includes a heater and a former. The heater heats stock 402 to a temperature at which the stock 402 becomes elastic and flexible. In some embodiments, the stock 402 is heated to a temperature at or above the material's glass transition temperature. Next, stock 402 is moved into the former of thermoformer 404, where it is molded into the desired shape. A mold is included in thermoformer 404, which is made of a material such as aluminum, wood, epoxy, or other metals or metal alloys. Stock 402 is applied to the mold where it is formed to the mold and cooled. In one embodiment, thermoformer 404 is a vacuum thermoformer that applies a suction to stock 402 to form stock 402 to the shape of the mold. In other embodiments, forming occurs by pressure forming, twin-sheet forming, drape forming, free blowing, and sheet bending. If desired, a single thermoforming operation can be used to form multiple targets from a single section of stock 404.

After stock 402 has passed through thermoformer 404, it can then be trimmed, such as with cutter 406. In one embodiment, cutter 406 includes a trimming die. The trimming die is formed to have the desired shape of edge 132 (e.g., shown in FIG. 3), such as the shape of a rabbit. In other embodiments, such as to form target 300, shown in FIG. 10, a rectangular trimming die is used. Cutter 406 trims excess stock 402 from the target. In addition, cutter 406 can also be used to form hang tag 210 (shown in FIG. 7) if desired, including hole 212 and perforation 214. In an alternative embodiment, cutter 406 includes a saw, laser, or other cutting device that operates to cut targets from stock 402.

After targets 100 (e.g., shown in FIG. 1) have been formed and cut from stock 402, targets 100 are passed through printer 408. Alternative embodiments print stock 402 before providing stock 402 to thermoformer 404 and cutter 406. In one embodiment, printer 408 operates to apply image 140 (e.g., shown in FIG. 6) to printing surface 110 of face 102 (e.g., shown in FIG. 1). One example of a suitable printer 408 is a digital printer, such as the Rho 600 flatbed UV inkjet printer manufactured by Durst Image Technology US LLC of Rochester, N.Y. Another example of a suitable printer 408 is a screen printer, such as the Hercules multicolor screen printing press manufactured by American M&M of Chicago, Ill. In some embodiments, printer 408 is a multi-color printer. In other embodiments, printer 408 prints only a single color, such as black. Other possible examples of printing techniques that are used in other embodiments include laser printing, offset lithography, relief printing, rotogravure, hot wax dye transfer, dot matrix, or other digital printing or xerography techniques. Some target embodiments do not include an image, and therefore printer 408 is not required.

After a target has been completed, the target can be stacked and/or packaged for delivery. This can be performed manually or automatically using an automated stacking and/or packaging machine.

In an alternate embodiment, stock 402 is preprinted, such that a printing process with printer 408 is not necessary. In another embodiment, printing is done by printer 408 prior to forming and cutting. In another embodiment, cutting with cutter 406 is performed prior to forming with thermoformer 404, or other forming method. In another embodiment, stock is printed with printer 408 and then cut with cutter 406, and a separate forming step is not required. In another embodiment, printing 408 is performed in multiple steps. One example includes printing an image on the target in a first step, and then selectively printing a second image at a subsequent time. An example of a second image is a bullseye, such as described with reference to FIG. 6.

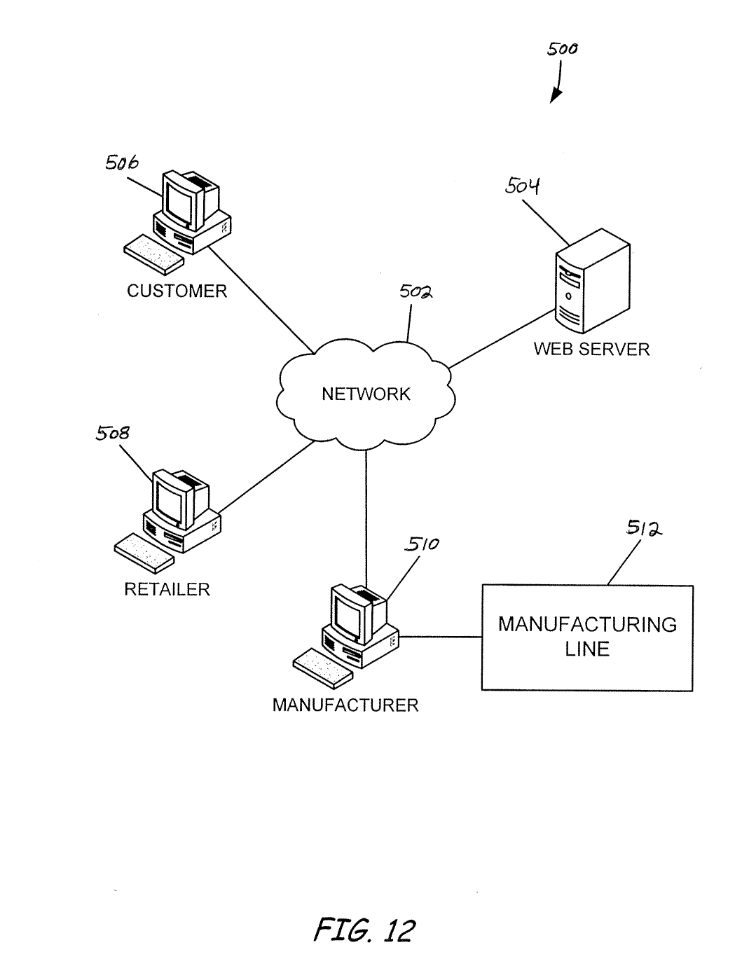

FIG. 12 is a block diagram illustrating an example system 500 for performing various tasks relating to target 100. System 500 includes communication network 502, web server 504, customer computing system 506, retailer computing system 508, manufacturer computing system 510, and manufacturing line 400. Web server 504, customer computing system 506, retailer computing system 508, and manufacturer computing system 510 are all communicatively connected to network 502, such that they can send and receive messages across network 502.

Web server 504 is a computing system configured to serve a web site for ordering targets 100. An example web site is illustrated with reference to FIGS. 12-14. Web server 504 is also configured to store information about products that are available for purchase from the manufacturer or retailer, and also to store information about purchase orders made through web server 504. In one embodiment, web server 504 is operating software, such as STOREFRONT® solution manufactured by LaGarde, Inc. of Olathe, Kan.

A customer can access a web site using customer computing system 506. Customer computing system 506 operates web browser software that enables customer computing system 506 to request a web site from web server 504 and to display the web site from data received from web server 504. The customer uses customer computing system 506 to obtain information about available products from web server 504 and to place an order for one or more products from web server 504.

In another possible embodiment, customer computing system 506 accesses a web site provided by retailer computing system 508. Retailer computing system 508 then redirects the customer to web server 504 where information about a target 100 is provided to the customer, or where an order for targets 100 is placed. The customer computing system 506 is then redirected back to the retailer computing system 508 where the order is completed or additional information is available. This embodiment is beneficial, for example, when a retailer wants to allow customers the ability to purchase products directly from a manufacturer, while still making it appear that the customer is making a purchase from the retailer.

Once an order has been placed through web server 504, web server 504 communicates the order information to manufacturer computing system 510. In one embodiment, manufacturer computing system 510 operates a web service that receives the order information and supplies the order information to manufacturing line 400. Manufacturing line 400 automatically manufactures the products identified in the order. In another embodiment, a message is communicated from web server 504 to manufacturer computing system 510, such as via an e-mail message. The e-mail message is read by the manufacturer, and the order is processed and manufactured accordingly.

Various additional data communication can also occur across system 500. For example, a confirmation is sent from manufacturer computing system 510 to customer computing system 506 after an order has been completed and has been shipped. As another example, order statistics or invoices are provided by web server 504 to retailer computing system 508. Various other data storage and communication services can also be provided, as desired.

Examples of computing systems include computers, data processing devices, hand held computers, cell phones, personal digital assistants, or other devices having a processing unit, memory, and a communication device.

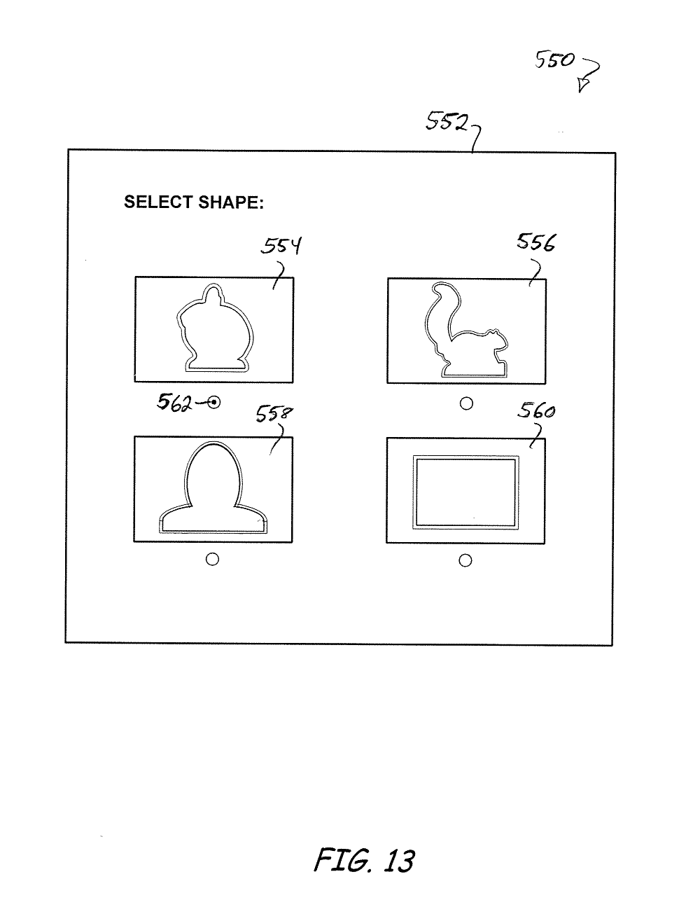

FIG. 13 is an example screen shot 552 of user interface 550 provided by web server 504 to customer computing system 506. In one embodiment, user interface 550 is displayed by an Internet browser software application operating on customer computing system 506. Web server 504 sends data to customer computing system 506, such as in hypertext markup language (HTML), or other known data communication format. The data is read by the browser software application, which displays the data as user interface 550 on a display of customer computing system 506.

Example screen shot 552 requests that the customer select the desired shape for a target. In this example, four shapes are available, such as a rabbit shape 554, squirrel shape 556, bust shape 558, or rectangular shape 560. Various other shapes are provided in other embodiments, including a square, circle, oval, triangle, or other multi-sided shapes. The customer selects the desired shape by using an input device, such as a keyboard or mouse of customer computing system 506 (shown in FIG. 12). In the illustrated example, the customer selects a radio button 562 associated with rabbit shape 554 to select the rabbit shape. Other customers might choose a different shape, such as a customer who desires to create a for sale sign. This customer might select a rectangular shape on which to apply the printed text for the sign.

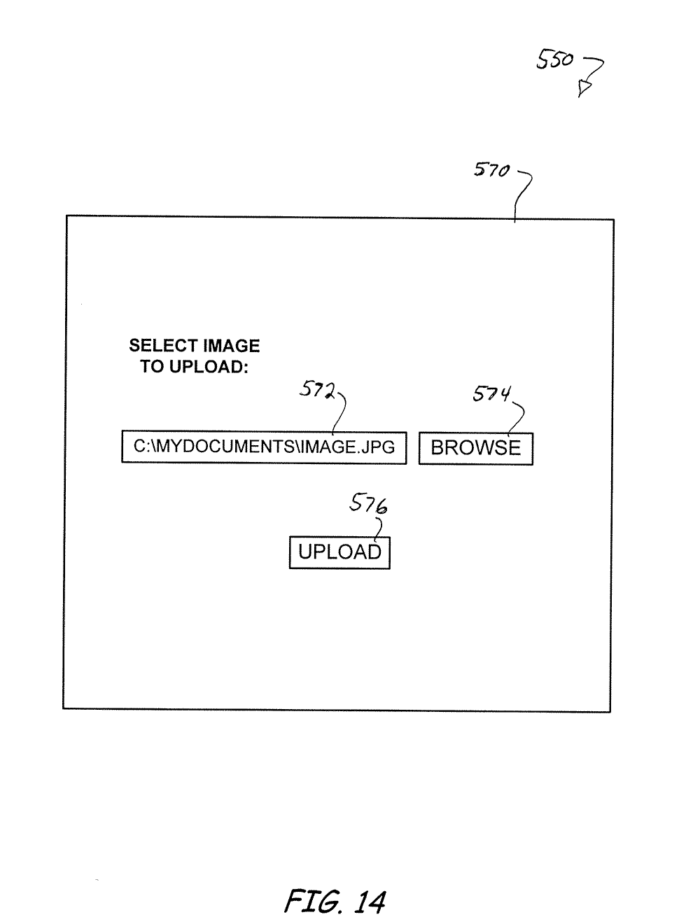

FIG. 14 is an example screen shot 570 of user interface 550 provided by web server 504 to customer computing system 506. Example screen shot 570 includes image identifier field 572, browse button 574, and upload button 576. Example screen shot 570 requests that the customer upload an image that is to be applied to the desired target shape (selected as shown in FIG. 13). This embodiment allows a customer to upload a custom image that will be applied to the target. Example images include an image of a game animal; an image of a disliked human, such as a boss, ex-spouse, neighbor, relative, political leader, and the like; a symbol, logo, or slogan, or any other desired image, drawing, graphic, or design.

In the illustrated example screen shot 570, the desired image is chosen by entering the file name and file location into image identifier field 572, or by selecting browse button 574 and searching the file system of customer computing system 506 to select the desired image. Upload button 576 is then selected to upload the image from customer computing system 506 to web server 504 (e.g., shown in FIG. 12). In alternative embodiments a custom image need not be provided, and instead the customer can select from a set of available images. In another embodiment, the customer is not given an option to select an image, but rather an image is automatically determined upon selection of a shape (e.g., shown in FIG. 13).

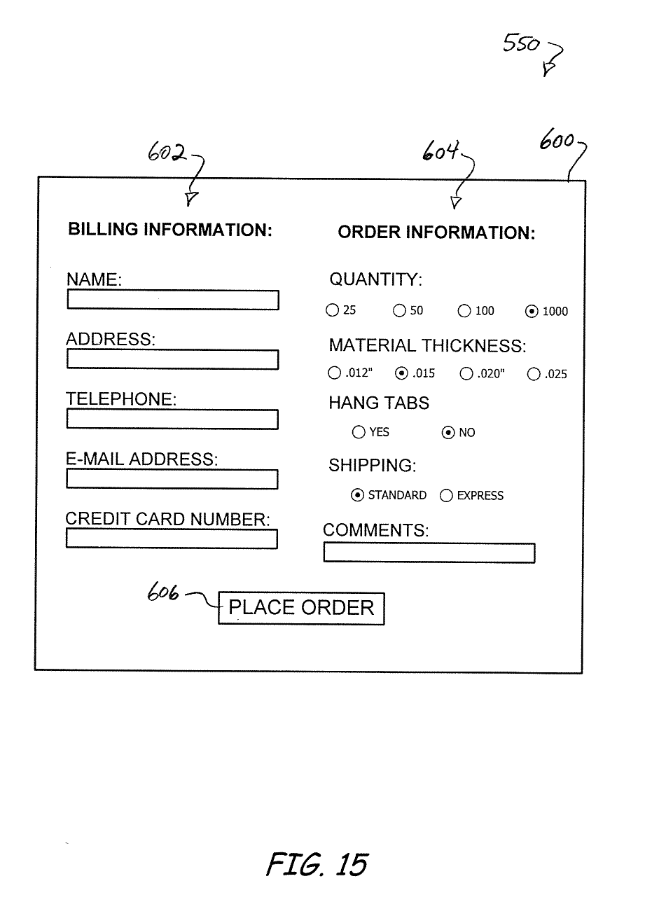

FIG. 15 is an example screen shot 600 of user interface 550. Screen shot 600 illustrates a screen in which billing information 602 and order information 604 are received from the user to complete the order. For example, the customer is prompted to enter billing information 602. Examples of billing information 602 include the name, address, telephone number, e-mail address of the customer, as well as payment information, such as a credit card type, number, expiration date, and security code. The customer is also prompted to enter additional order information 604. Examples of order information include the quantity to be ordered, desired stock material thickness to be used, whether hang tabs should be included, whether the customer prefers standard or express delivery, and general comments from the customer. After billing information 602 and order information 604 have been entered, place order button 606 is selected. The information is then transmitted from customer computing system 506 to web server 504 where the information is verified and order information is communicated to manufacturer computing system 510.

The above examples of user interface 550 are provided only as examples of possible user interface displays that could be provided by web server 504, but it is recognized that a wide variety of alternatives exist, all of which are within the spirit and scope of the present disclosure. In addition, none of the features of user interface 550 that are illustrated and described are required by all embodiments.

Other embodiments of target 100 are ordered through other known methods. For example, target 100 can be ordered through the mail, such as from a catalog, or a telephone order can be placed. Other methods of ordering products are known in the art and need not be described in detail herein.

Although the present disclosure has been described with reference to targets, it is recognized that there is no requirement that the targets described be actually used as targets. Rather, various other uses of these products are also possible, such as for signs or displays. In one example the word “SALE” is printed on the target, which is used to advertise a yard sale, garage sale, or bargain sale at a retail store. In another example, a customer orders a sign having a custom image of his son printed on it, and uses the sign to cheer on and encourage his son during the sporting event. These and other uses of the “targets” described herein are all within the spirit and scope of the present disclosure.

The above specification, examples and data provide a complete description of the manufacture and use of the composition of the invention. It is noted that all of the features characterized herein need not be incorporated within a given arrangement for the arrangement to include improvements according to the present disclosure.

What is claimed is:

1. An apparatus comprising:
a face member having a first edge at least partially surrounding the face member;
a side wall having a second edge and a third edge, the side wall being connected to the first edge at the second edge; and
an image layer on the face member.

2. The apparatus of claim 1, wherein the face member is substantially planar.

3. The apparatus of claim 1, further comprising a flange having a fourth edge and a fifth edge, the flange being connected to the third edge of the side wall at the fourth edge.

4. The apparatus of claim 1, wherein the side wall extends at least partially in a direction normal to the face member.

5. The apparatus of claim 1, wherein the image layer is a likeness of a mammal selected from the group comprising: a rabbit, a squirrel, a deer, a moose, an elk, a reindeer, an antelope, a human, a turkey, a pheasant, a grouse, a goose, a duck, and a bear.

6. The apparatus of claim 5, wherein the printed image further comprises a bullseye.

7. The apparatus of claim 1, wherein the side wall has an angle from a direction normal to the face member in a range from two degrees to five degrees.

8. The apparatus of claim 1, further comprising a hang tag.

9. The apparatus of claim 1, wherein the first edge is arranged in a shape resembling a game animal.

10. The apparatus of claim 9, wherein the first edge forms a first shape and the fifth edge forms a second shape, and wherein the second shape is an enlarged version of the first shape.

11. A method of forming a target, the method comprising:
obtaining a sheet of material;
heating the sheet of material;
using a mold to define a face member, side wall member, and flange member from the heated sheet of material;
cooling the sheet of material after defining the face member, side wall member, and flange member;
removing an excess portion of the flange member; and
printing an image on the sheet of material.

12. The method of claim 11, wherein using a mold to define a face member comprises using a mold to define a substantially planar face member.

13. The method of claim 11, wherein a vacuum thermoformer is used in conjunction with the mold to define the face member, side wall member, and flange member.

14. The method of claim 11, wherein using a mold to define a face member and a side wall member comprises using a mold to define a face member and a side wall member having shapes related to the image to be printed on the face member.

15. The method of claim 14, wherein the shapes mimic an object selected from the group comprising: a game animal, a portion of a game animal, a human, and a portion of a human.

16. The method of claim 11, further comprising:
sending data including product information across a network;
receiving order information from the network in response to the product information, wherein sending data and receiving customization selections occur before heating the sheet of material and before printing the image.

17. The method of claim 11, wherein the order information includes an identification of a shape of the mold and the image to be printed on the sheet of material.

18. A target comprising:
a face member having a substantially planar printing surface, the face member having a first edge at least partially surrounding the face member, the first edge having a shape of an animal;
an image on the substantially planar surface of the face member, the image including the likeness of the animal;
a side wall having a second edge and a third edge, the side wall connected to the first edge at the second edge, the side wall extending from the first edge, the third edge having the shape of the animal; and
a flange having a fourth edge and a fifth edge, the flange member connected to the third edge at the fourth edge, the flange member extending from the third edge in a direction substantially parallel with a plane of the substantially planar printing surface.

19. The target of claim 18, wherein the face member has a thickness in a range from 0.012 inches to 0.025 inches.

20. The target of claim 18, wherein the target is formed of a material selected from the group comprising: polyvinyl chloride, high impact polystyrene, and polyethylene.
